(19) United States
(12) Patent Application Publication
(10) Pub. No.: US 2012/0281841 A1
(43) Pub. Date: Nov. 8, 2012

(54) APPARATUS AND METHOD FOR ENCODING/DECODING A MULTI-CHANNEL AUDIO SIGNAL

(75) Inventors: Mi Young Kim, Yongin-si (KR); Eun Mi Oh, Yongin-si (KR); Yurkov Kirill, Saint-Petersburg (RU); Kudryashov Boris, Saint-Petersburg (RU); Porov Anton, Saint-Petersburg (RU); Osipov Konstantin, Saint-Petersburg (RU)

(73) Assignee: SAMSUNG ELECTRONICS CO., LTD., Suwon-si (KR)

(21) Appl. No.: 13/508,266

(22) PCT Filed: Nov. 4, 2010
(86) PCT No.: PCT/KR2010/007728

§ 371 Date: Jul. 24, 2012

(30) Foreign Application Priority Data
Nov. 4, 2009 (KR) 10-2009-0105904

(51) Int. Cl. H04R 5/00

(52) U.S. Cl. 381/22; 381/23

(57) ABSTRACT

Disclosed is an apparatus and method for encoding and decoding a multichannel audio signal. The encoding apparatus may compute a weight matrix from a multichannel audio signal to be encoded, and may extract a base signal from the multichannel audio signal using the computed weight matrix.

### TECHNICAL FIELD

Example embodiments relate to an apparatus and method for encoding or decoding a multichannel audio signal.

### BACKGROUND ART

To transfer more realistic music to a listener, music generated from a sound source may be recorded to multiple channels using a plurality of microphones. Audio data recorded to multiple channels may have a great capacity and thus, research on technology capable of efficiently encoding recorded data has been conducted.

For example, research on technology for encoding a multichannel audio signal using a spatial perceptive characteristic between channels such as an inter-channel intensity difference (IID) or channel level differences (CLD) indicating an intensity difference based on energy levels of at least two channel signals among channel signals included in the multichannel audio signal, an inter-channel coherence or inter-channel correlation (ICC) indicating correlation between two channel signals based on similarity between the respective channel signal waveforms, an inter-channel phase difference (IPD) indicating a phase difference between the respective channel signals, and the like.

In the case of multichannel audio, the number of channels such as 10.2 channel, 22.2 channel, and the like, has been increasing according to a demand for the high sense of reality. Accordingly, there is a desire for audio encoding technology that may provide high quality sound by efficiently removing overall inter-channel overlapping information.

### DISCLOSURE OF INVENTION

### Technical Solutions

According to example embodiments, there is provided an apparatus for encoding an audio signal, including: a frequency domain transformer to transform a multichannel audio signal of a time domain to a frequency domain; a base signal extractor to compute a weight matrix about the frequency domain transformed multichannel audio signal, and to extract a base signal of at least one channel from the frequency domain transformed multichannel audio signal based on the weight matrix; and an audio signal encoder to encode the base signal.

According to other example embodiments, there is provided an apparatus for decoding an audio signal, including: a signal restoration unit to restore a multichannel audio signal using a weight matrix that is computed based on the multichannel audio signal and a base signal that is extracted from the multichannel audio signal; and a time domain transformer to transform the restored multichannel audio signal to a time domain.

According to still other example embodiments, there is provided a method of encoding an audio signal, including: transforming a multichannel audio signal of a time domain to a frequency domain; computing a weight matrix about the frequency domain transformed multichannel audio signal; extracting a base signal of at least one channel from the frequency domain transformed multichannel audio signal based on the weight matrix; and encoding the base signal.

### Effect of the Invention

According to example embodiments, an apparatus and method for encoding a multichannel audio signal may decrease capacity of audio data.

Also, according to example embodiments, an apparatus and method for encoding and decoding a multichannel audio signal may provide a multichannel audio signal with the enhanced sound quality.

### BRIEF DESCRIPTION OF DRAWINGS

FIG. 1, parts (a) and (b), illustrate an example of a multichannel audio signal;

FIG. 2 is a block diagram illustrating a structure of an audio signal encoding apparatus according to an embodiment.

FIG. 3 is a block diagram illustrating a base signal extractor according to an embodiment.

FIG. 4 is a block diagram illustrating a structure of an audio signal decoding apparatus according to an embodiment.

FIG. 5 is a flowchart illustrating an audio signal encoding method according to an embodiment.

FIG. 6 is a flowchart illustrating a base signal extracting method according to an embodiment; and

FIG. 7 is a flowchart illustrating an audio signal decoding method according to an embodiment.

### BEST MODE FOR CARRYING OUT THE INVENTION

Reference will now be made in detail to example embodiments, examples of which are illustrated in the accompanying drawings, wherein like reference numerals refer to the like elements throughout. Example embodiments are described below in order to explain example embodiments by referring to the figures.

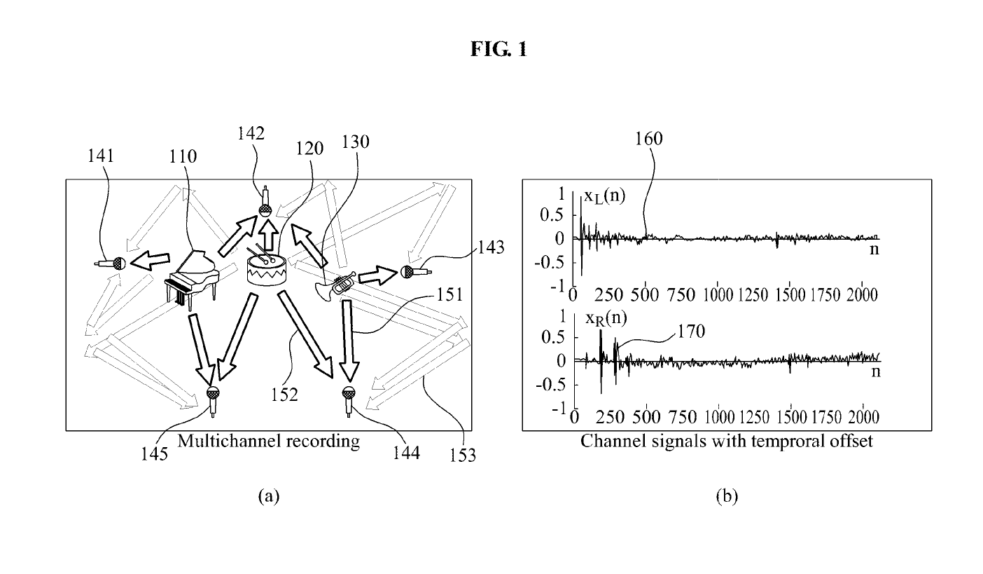

FIG. 1, parts (a) and (b), illustrate an example of a multichannel audio signal.

Part (a) of FIG. 1 shows an example of recording a multichannel audio signal. Three musical instruments 110, 120, and 130 are being played in the center indoors. Music transmitted from each of the musical instruments 110, 120, and 130 may be recorded using five microphones 141, 142, 143, 144, and 145. Each of the microphones 141, 142, 143, 144, and 145 may convert music to an audio signal. As shown in part (a) of FIG. 1, when an audio signal is generated using the plurality of microphones 141, 142, 143, 144, and 145, music generated by each of the musical instruments 110, 120, and 130 may be recorded as a multichannel audio signal. Music recorded by each of the microphones 141, 142, 143, 144, and 145 may be each channel of the multichannel audio signal.

Music generated by the respective musical instruments 110, 120, and 130 microphones may be directly input to the respective corresponding microphones 141, 142, 143, 144, and 145, as indicated by indicators 151 and 152, and may also be reflected by walls and the like and thereby be input to the respective corresponding microphones 141, 142, 143, 144, and 145 as indicated by an indicator 153.

Part (b) of FIG. 1 is a graph showing each channel of a multichannel audio signal. The graph shown in part (b) of FIG. 1 shows only two channels 160 and 170 in the recorded multichannel audio signal of part (a) of FIG. 1. Referring to part (b) of FIG. 1, the channels 160 and 170 may have a similar form, but may have different time delays. That is, it can be seen that the channel 170 is recorded in such a manner that the channel 160 is time delayed.

Each of the channels 160 and 170 has recorded music that is generated from the same musical instruments 110, 120, and 130 and thus, the channels 160 and 170 may have a similar form. However, a time delay of each of the channels 160 and 170 may vary depending on a position of each of the microphones 141, 142, 143, 144, and 145.

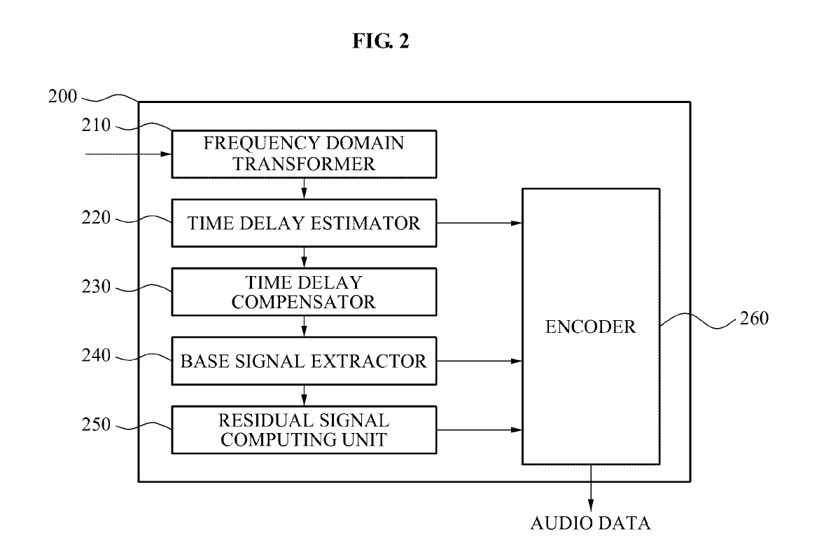

FIG. 2 is a block diagram illustrating a structure of an audio signal encoding apparatus according to an embodiment.

An audio signal encoding apparatus 200 may include a frequency domain transformer 210, a time delay estimator 220, a time delay compensator 230, a base signal extractor 240, a residual signal computing unit 260, and an encoder 260.

The audio signal encoding apparatus 200 may receive a multichannel audio signal. According to an embodiment, a multichannel audio signal received by the audio signal encoding apparatus 200 may be a signal that is directly recorded from a sound source as shown in part (a) of FIG. 1.

According to another embodiment, a multichannel audio signal received by the audio signal encoding apparatus 200 may be an audio signal tfiat is preprocessed by reflecting a perceptual characteristic of a human. A human may not identify all the frequency bands of sound recorded music at the same intensity. A human may precisely identify a predetermined frequency band, but may not identify or cannot even hear another frequency band. Accordingly, by reflecting a perceptual characteristic of a human during a preprocessing process, a signal of the predetermined frequency band may be excluded from an audio signal.

The frequency domain transformer 210 may transform a multichannel audio signal of a time domain to a frequency domain. As shown in FIG. 1, a multichannel audio signal of a time domain may be generated using the plurality of microphones 141, 142, 143, 144, and 145. The frequency domain transformer 210 may transform the multichannel audio signal of the time domain to the frequency band.

According to an embodiment, the frequency domain transformer 210 may transform a multichannel audio signal of a time domain to a frequency band using a transformation scheme such as modified discrete cosine transform (MDCT), quadrature mirror filter (QMF), and the like, for example.

The time delay estimator 220 may estimate a time delay parameter between channels. As shown in part (b) of FIG. 1, channels may have a similar form and only time delays of the channels may be different from each other. In this example, each time delay parameter may indicate a specific time delay level between channels.

A time delay parameter may be expressed as a filter coefficient value by a linear combination of signals that are moved to a time axis with respect to a channel signal. A magnitude component of a channel signal as well as a time delay may be estimated using the filter coefficient value.

The time delay compensator 230 may compensate for a time delay of each channel using a time delay parameter. When the time delay of each channel is compensated for, an audio signal may be initiated at similar points in times and a peak may occur at similar points in times. That is, inter-channel correlation may significantly increase.

The base signal extractor 240 may compute a weight matrix with respect to a frequency domain transformed audio signal, and may extract a base signal. The base signal extractor 240 may compute a weight matrix from a time delay compensated audio signal. The base signal extractor 240 may extract a base signal from a frequency domain audio signal based on the computed weight matrix.

The base signal is a signal that maintains a common feature of a multichannel audio signal, and may include a single channel and may also include multiple channels. According to an embodiment, the number of channels of the base signal may be less than the number of channels of the multichannel audio signal.

An operation of the base signal extractor 240 to compute a weight matrix from a multichannel audio signal, and to extract a base signal from the multichannel audio signal using the weight matrix will be further described later.

An audio signal decoding apparatus may restore an audio signal based on the base signal and the weight matrix. A multichannel audio signal that is input to the audio signal encoding apparatus 200 may be different from the restored audio signal. Hereinafter, a multichannel audio signal that is input to the audio signal encoding apparatus 200 may be referred to as a source audio signal, and an audio signal restored using the weight matrix and the base signal may be referred to as a restored audio signal.

A difference between the restored audio signal and the source audio signal may be referred to as a residual signal. When the base signal extractor 240 effectively extracts the base signal, magnitude of the residual signal may be significantly small. When magnitude of the residual signal is large, there may be difference between sound quality of the source audio signal and sound quality of the restored audio signal.

The residual signal computing unit 260 may compute the difference between the source audio signal and the restored audio signal as the residual signal.

In this case, the audio, signal decoding apparatus may generate an audio signal further closer to the source audio signal by synthesizing the restored audio signal and the residual signal. The audio signal generated by synthesizing the restored audio signal and the residual signal may be referred to as a decoded audio signal. Since the audio signal decoded using the residual signal is similar to the source audio signal, the sound quality of the decoded audio signal may be very similar to the sound quality of the source audio signal.

The encoder 260 may encode the base signal, the weight matrix, and the residual signal. According to an embodiment, the audio signal decoding apparatus may restore an audio signal by decoding the encoded base signal and the weight matrix. The sound quality of the restored audio signal may be different from the sound quality of the source audio signal and thus, the audio signal decoding apparatus may generate an audio signal further closer to the source audio signal by synthesizing the restored audio signal and the residual signal.

The encoder 260 may encode a base signal having the number of channels less than the number of channels of a multichannel audio signal. Accordingly, a size of audio data to be encoded may decrease and thus, the audio data may be further efficiently encoded.

According to an embodiment, the encoder 260 may additionally encode a time delay parameter with respect to each channel of a multichannel audio signal.

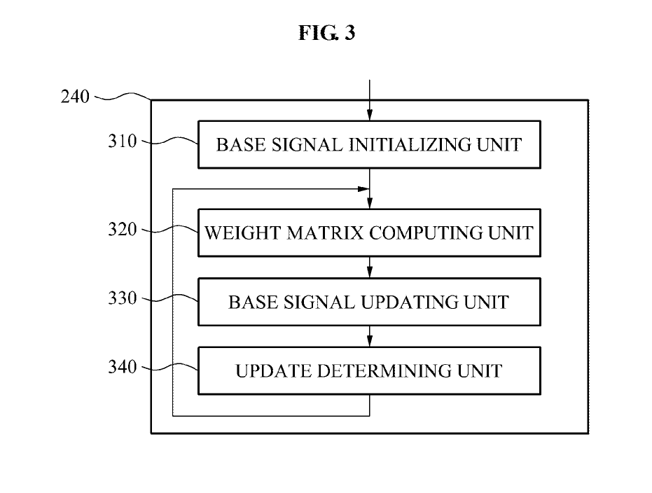

FIG. 3 is a block diagram illustrating a base signal extractor according to an embodiment.

The base signal extractor 240 may include a base signal initializing unit 310, a weight matrix computing unit 320, a base signal updating unit 330, and an update determining unit 340.

The base signal initializing unit 310 may initialize a base signal. According to an embodiment, the base signal initializing unit 310 may select, from a multichannel audio signal, an audio signal of a channel having the highest energy as an initial value of the base signal.

The weight matrix computing unit 310 may compute a weight matrix based on the initialized base signal. According to an embodiment, the weight matrix computing unit 310 may compute a weight matrix to minimize magnitude of a residual signal that is a difference between a restored audio signal and a source audio signal, and may extract a base signal using the computed weight matrix, which may be expressed by Equation 1.

∥Y−Ŷ∥²=∥Y−WX∥² [Equation 1]

In Equation 1, Y denotes an audio signal vector that includes each of channels of the source audio signal as an element, Ŷ denotes a restored audio signal vector that includes each of channels of the restored audio signal as an element, W denotes the weight matrix, and X denotes a base signal vector.

The weight matrix computing unit 320 may compute the weight matrix according to Equation 2.

W=YX^{T}(XX^{T})⁻¹ [Equation 2]

In Equation 2, W denotes the weight matrix, Y denotes the audio signal vector that includes each of channels of the source audio signal as an element, X denotes an initialized base signal vector, and X^{T} denotes a conjugate complex matrix of X.

The base signal updating unit 330 may update the base signal based on the computed base signal. According to an embodiment, the base signal updating unit 330 may update a base signal according to Equation 3.

X=(WW^{T})⁻¹W^{T}Y [Equation 3]

In Equation 3, W denotes the weight matrix, Y denotes the audio signal vector that includes each of channels of the source audio signal as an element, and X denotes the base signal vector.

The update determining unit 340 may determine whether an end condition of base signal extraction is satisfied. According to an embodiment, when the base signal is determined to not satisfy the end condition, the weight matrix computing unit 320 may re-compute the weight matrix based on the updated base signal, and the base signal updating unit 330 may update gain the base signal based on the re-computed weight matrix.

According to an embodiment, the end condition may be associated with error energy magnitude of the source audio signal Y and Ŷ that is a signal predicted from the base signal and the weight matrix. For example, the update determining unit 340 may compare the error energy magnitude with a predetermined threshold, and may determine that the base signal satisfies the end condition when the error energy magnitude is less than the threshold.

According to another embodiment, the end condition may be associated with the number of times that the base signal is updated. For example, when the number of times that the base signal is updated is greater than a predetermined threshold value, the update determining unit 340 may determine that the base signal satisfies the end condition.

According to still another embodiment, the end condition may be associated with a change in the error energy magnitude. The error energy magnitude may decrease according to update of the base signal. For example, first error energy magnitude that is generated based on a weight matrix computed during a previous iterative computation process is greater than second error energy magnitude that is generated based on a weight matrix re-computed during a subsequent iterative computation process. The update determining unit 340 may compare the first error energy magnitude and the second error energy magnitude, and may determine whether the base signal satisfies the end condition based on the comparison result.

For example, when a ratio of decrease in the error energy magnitude according to update of the base signal is less than a predetermined threshold ratio, the update determining unit 340 may determine that the base signal satisfies the end condition.

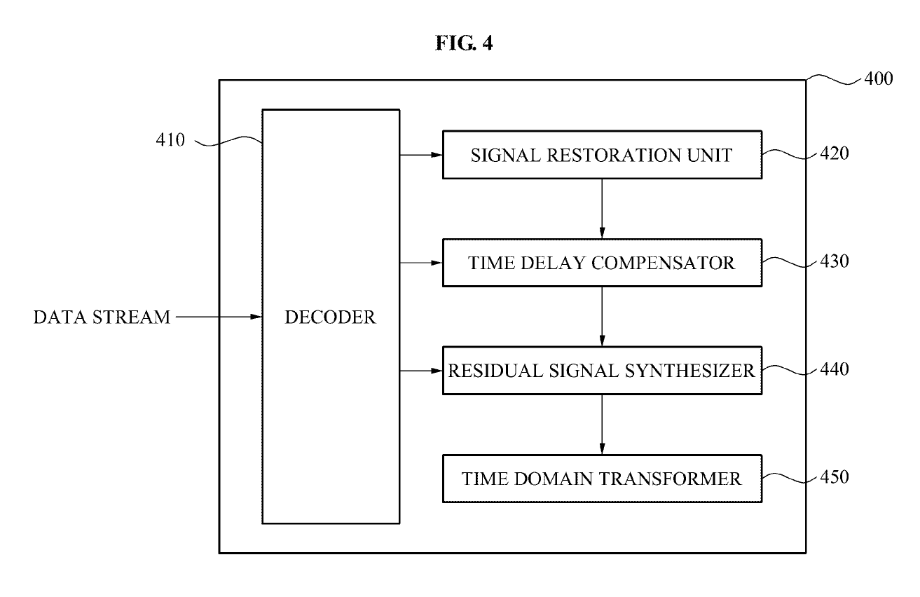

FIG. 4 is a block diagram illustrating a structure of an audio signal decoding apparatus according to an embodiment.

An audio signal decoding apparatus 400 may include a decoder 410, a signal restoration unit 420, a time delay compensator 430, a residual signal synthesizer 440, and a time domain transformer 450.

The decoder 410 may decode an encoded weight matrix, base signal, and residual signal.

The signal restoration unit 420 may restore an audio signal from the base signal using the weight matrix. According to an embodiment, the weight matrix may be computed based on a multichannel audio signal, and the base signal may be extracted from the multichannel audio signal using the weight matrix.

The signal restoration unit 420 may generate a restored audio signal according to Equation 4.

Ŷ=WX [Equation 4]

In Equation 4, W denotes the weight matrix, X denotes the base signal, and Ŷ denotes a restored audio signal vector that includes each of channels of the restored audio signal as an element.

The time delay compensator 430 may compensate for a time delay of each of the restored channels using a time delay parameter for each of the channels. Each time delay compensated channel may have a different start point in time and peak generation point in time as shown in part (b) of FIG. 1.

The residual signal synthesizer 440 may synthesize the restored audio signal and the residual signal. Since there may be a difference between the restored audio signal and the source audio signal, the residual signal synthesizer 440 may generate the restored audio signal similar to the source audio signal by synthesizing the restored audio signal with a residual signal corresponding to the difference.

The time domain transformer 450 may transform each decoded channel audio signal to a time domain. According to an embodiment, the time domain transformer 450 may transform a decoded audio signal to a time domain using an inverse transformation scheme such as inverse MDCT (IMDCT), inverse QMF (IQMF), and the like, for example.

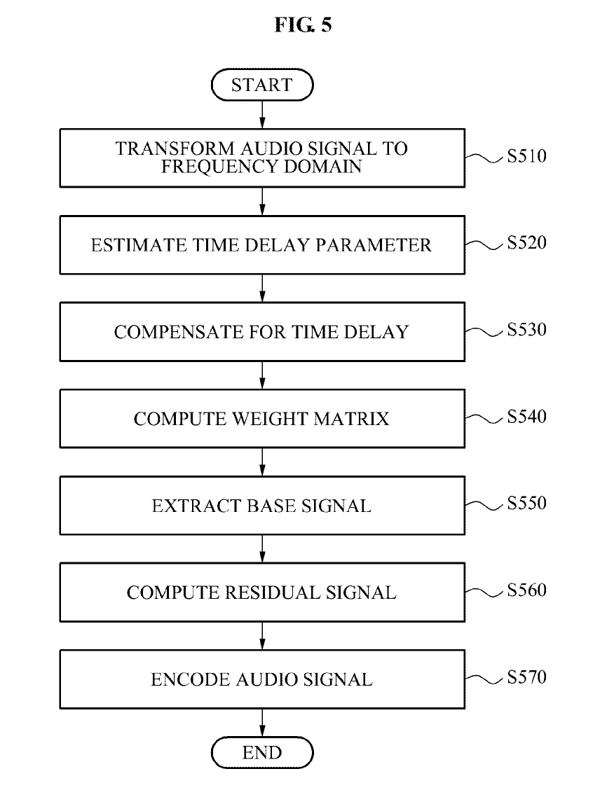

FIG. 5 is a flowchart illustrating an audio signal encoding method according to an embodiment.

In operation S510, an audio signal encoding apparatus may transform a multichannel audio signal of a time domain to a frequency domain. According to an embodiment, a multichannel audio signal received by the audio signal encoding apparatus may be a signal that is directly recorded from a sound source. According to another embodiment, a multichannel audio signal received by the audio signal encoding apparatus may be an audio signal that is preprocessed by reflecting a perceptual characteristic of a human.

According to an embodiment, the audio signal encoding apparatus may transform a time domain multichannel audio signal to a frequency band using a transformation scheme such as MDCT, QMF, and the like, for example.

In operation S520, the audio signal encoding apparatus may estimate a time delay parameter of the frequency domain transformed multichannel audio signal. As shown in part (a) of FIG. 1, when sound generated from the same sound source is recorded, each channel audio signal may have a form similar to a time delayed signal of another channel audio signal.

In operation S530, the audio signal encoding apparatus may compensate for a time delay of an audio signal of each channel using the time delay parameter. Correlation between the respective compensated channel audio signals may increase, such as peaks occurring at similar points in times.

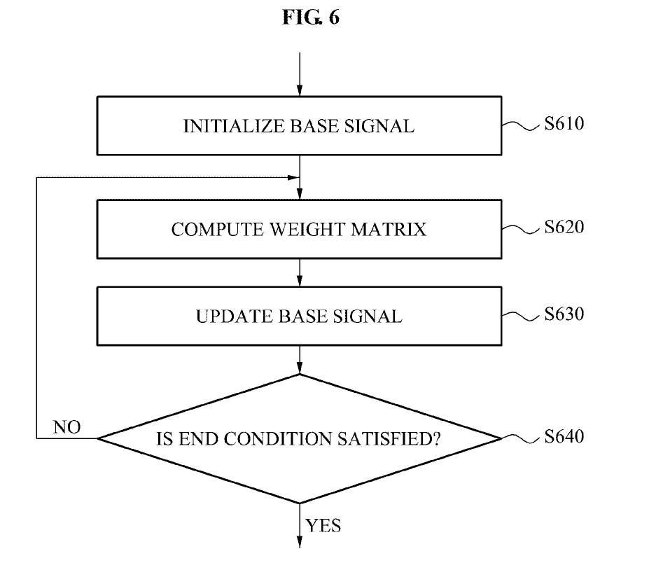

In operation S540, the audio signal encoding apparatus may compute a weight matrix with respect to a frequency domain transformed audio signal. A detailed configuration of computing the weight matrix will be described with reference to FIG. 6. According to an embodiment, the audio signal encoding apparatus may compute a weight matrix using a multichannel audio signal of which time delay is compensated for and thus, of which correlation is enhanced.

In operation S550, the audio signal encoding apparatus may extract a base signal from the multichannel audio signal. The audio signal encoding apparatus may extract the base signal based on the weight matrix. The base signal may include a plurality of channels. In this case, the number of channels of the base signal may be less than the number of channels of the multichannel audio signal. A detailed configuration of extracting the base signal from the multichannel audio signal will be described with reference to FIG. 6.

In operation S560, the audio signal encoding apparatus may compute a difference between a restored audio signal and a source audio signal as a residual signal.

In operation S570, the audio signal encoding apparatus may encode the base signal and the weight matrix. The audio signal encoding apparatus may additionally encode the residual signal.

An audio signal decoding apparatus may restore an audio signal using the weight matrix and the base signal, and may decode the audio signal by adding the restored audio signal and the residual signal.

In operation S570, the audio signal encoding apparatus may encode the base signal having the number of channels less than the number of channels of the multichannel audio signal, instead of directly encoding the multichannel audio signal. Accordingly, capacity of encoded audio data may decrease.

In operation S570, the audio signal encoding apparatus may encode the time delay parameter.

FIG. 6 is a flowchart illustrating a base signal extracting method according to an embodiment.

In operation S610, the audio signal encoding apparatus may initialize the base signal. According to an embodiment, the audio signal encoding apparatus may select, from the multichannel audio signal as an initial value of the base signal, an audio signal of portion of channels.

In operation S620, the audio signal encoding apparatus may compute the weight matrix based on the initialized base signal. According to an embodiment, the audio signal encoding apparatus may compute the weight matrix according to Equation 5.

W=YX^{T}(XX^{T})⁻¹ [Equation 5]

In Equation 5, W denotes the weight matrix, Y denotes an audio signal vector that includes each of channels of the source audio signal as an element, and X denotes an initialized base signal vector.

In operation S630, the audio signal encoding apparatus may update the base signal based on the computed weight matrix. According to an embodiment, the audio signal encoding apparatus may update the base signal according to Equation 6.

X=(WW^{T})⁻¹W^{T}Y [Equation 6]

In Equation 6, W denotes the weight matrix, Y denotes the audio signal vector that includes each of channels of the source audio signal as an element, and X denotes the base signal.

In operation S640, the audio signal encoding apparatus may determine whether an end condition of base signal extraction is satisfied. When the extracted base signal is determined to not satisfy the end condition, the audio signal encoding apparatus may re-compute the weight matrix based on the updated base signal X in operation S620. Also, the audio signal encoding apparatus may update gain the base signal X based on the re-computed weight matrix in operation S630.

According to an embodiment, the end condition may be associated with error energy magnitude of the source audio signal Y and Ŷ that is a signal predicted from the base signal and the weight matrix. For example, the audio signal encoding apparatus may compare the error energy magnitude with a predetermined threshold, and may determine that the base signal satisfies the end condition when the error energy magnitude is less than the threshold.

According to another embodiment, the end condition may be associated with the number of times that the base signal is updated. For example, when the number of times that the base signal is updated is greater than a predetermined threshold value, the audio signal encoding apparatus may determine that the base signal satisfies the end condition in operation S640.

According to still another embodiment, the end condition may be associated with a change in the error energy magnitude. The error energy magnitude may decrease according to update of the base signal. When a ratio of decrease in the error energy magnitude according to update of the base signal is less than a predetermined threshold ratio, the audio signal encoding apparatus may determine that the base signal satisfies the end condition.

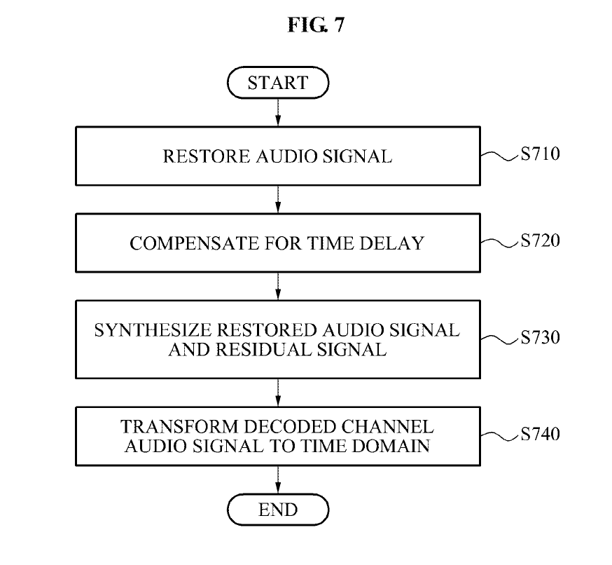

FIG. 7 is a flowchart illustrating an audio signal decoding method according to an embodiment.

In operation S710, an audio signal decoding apparatus may restore a multichannel audio signal from a weight matrix and a base signal. According to an embodiment, the weight matrix may be computed based on the multichannel audio signal, and the base signal may be extracted from the multichannel audio signal.

In operation S710, the audio signal decoding apparatus may generate a restored audio signal according to Equation 7.

Ŷ=WX [Equation 7]

In Equation 7, W denotes the weight matrix, X denotes the base signal, and Ŷ denotes a restored audio signal vector that includes each of channels of the restored audio signal as an element.

In operation S720, the audio signal decoding apparatus may compensate for a time delay of each of the restored channels using a time delay parameter for each of the channels. Each time delay compensated channel may have a different start point in time and peak generation point in time as shown in part (b) of FIG. 1.

In operation S730, the audio signal decoding apparatus may synthesize the restored audio signal and the residual signal. Since there may be a difference between the restored audio signal and the source audio signal, the audio signal decoding apparatus may generate the restored audio signal similar to the source audio signal by synthesizing the restored audio signal with a residual signal corresponding to the difference.

In operation S740, the audio signal decoding apparatus may transform each decoded channel audio signal to a time domain. According to an embodiment, the audio signal decoding apparatus may transform a decoded audio signal to a time domain using an inverse transformation scheme such as IMDCT, IQMF, and the like, for example.

The method of encoding and decoding the multichannel audio signal according to example embodiments may include computer-readable media including program instructions to implement various operations embodied by a computer. The media may also include, alone or in combination with the program instructions, data files, data structures, tables, and the like. The media and program instructions may be those specially designed and constructed for the purposes of example embodiments, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

Although a few example embodiments have been shown and described, the present disclosure is not limited to the described example embodiments. Instead, it would be appreciated by those skilled in the art that changes may be made to these example embodiments without departing from the principles and spirit of the disclosure, the scope of which is defined by the claims and their equivalents.

1. An apparatus for encoding an audio signal, comprising:
a frequency domain transformer to transform a multichannel audio signal of a time domain to a frequency domain;
a base signal extractor to compute a weight matrix about the frequency domain transformed multichannel audio signal, and to extract a base signal of at least one channel from the frequency domain transformed multichannel audio signal based on the weight matrix; and
an audio signal encoder to encode the base signal.

2. The apparatus of claim 1, further comprising:
a time delay estimator to estimate a time delay parameter of the frequency domain transformed multichannel audio signal for each channel; and
a time delay compensator to compensate for a time delay of the multichannel audio signal using the time delay parameter,
wherein the base signal extractor extracts the base signal from the time delay compensated multichannel audio signal.

3. The apparatus of claim 1, further comprising:
a residual signal computing unit to compute a difference between a restored audio signal and the multichannel audio signal as a residual signal using the weight matrix and the base signal,
wherein the audio signal encoder encodes the residual signal.

4. The apparatus of claim 3, wherein the base signal extractor computes the weight matrix to minimize magnitude of the residual signal.

5. The apparatus of claim 1, wherein the base signal extractor comprises:
a base signal initializing unit to initialize the base signal;
a weight matrix computing unit to compute the weight matrix based on the initialized base signal; and
a base signal updating unit to update the base signal based on the computed weight matrix,
wherein the weight matrix computing unit re-computes the weight matrix based on the updated base signal.

6. The apparatus of claim 5, wherein the base signal extractor further comprises:
an update determining unit whether to update the base signal by comparing a residual signal generated based on the computed weight matrix and a residual signal generated based on the re-computed weight matrix.

7. An apparatus for decoding an audio signal, comprising:
a signal restoration unit to restore a multichannel audio signal using a weight matrix that is computed based on the multichannel audio signal and a base signal that is extracted from the multichannel audio signal; and
a time domain transformer to transform the restored multichannel audio signal to a time domain.

8. The apparatus of claim 7, further comprising:
a time delay compensator to compensate for a time delay of an audio signal of each channel using a time delay parameter for each channel of the multichannel audio signal.

9. The apparatus of claim 7, further comprising:
a residual signal synthesizer to synthesize a residual signal with respect to the multichannel audio signal and the restored multichannel audio signal.

10. A method of encoding an audio signal, comprising:
transforming a multichannel audio signal of a time domain to a frequency domain;
computing a weight matrix about the frequency domain transformed multichannel audio signal;
extracting a base signal of at least one channel from the frequency domain transformed multichannel audio signal based on the weight matrix; and
encoding the base signal.

11. The method of claim 10, further comprising:
estimating a time delay parameter of the frequency domain transformed multichannel audio signal; and
compensating for a time delay of an audio signal of each channel using the time delay parameter,
wherein the computing comprises computing the weight matrix from the time delay compensated multichannel audio signal.

12. The method of claim 10, further comprising:
restoring the multichannel audio signal from the base signal using the weight matrix;
computing a difference between the multichannel audio signal and the restored audio signal of each channel as a residual signal; and
encoding the residual signal.

13. The method of claim 10 wherein the extracting comprises:
initializing the base signal
computing the weight matrix based on the initialized base signal; and
updating the base signal based on the computed weight matrix,
wherein the computing comprises re-computing the weight matrix based on the updated base signal.

14. A method of decoding an audio signal, comprising:
restoring a multichannel audio signal using a weight matrix that is computed based on the multichannel audio signal and a base signal that is extracted from the multichannel audio signal; and
transforming the restored multichannel audio signal to a time domain.

15. The method of claim 14, further comprising:
compensating for a time delay of an audio signal of each channel using a time delay parameter for each channel of the multichannel audio signal.

16. The method of claim 14, further comprising:
synthesizing a residual signal with respect to the multichannel audio signal and the restored multichannel audio signal.

17. A non-transitory computer-readable medium comprising a program for instructing a computer to perform the method according to any one of claims 10 through 16.
